(19) United States
(12) Patent Application Publication
(10) Pub. No.: US 2016/0034069 A1
(43) Pub. Date: Feb. 4, 2016

(54) INFORMATION PROCESSING APPARATUS, INPUT CONTROL METHOD, AND COMPUTER-READABLE RECORDING MEDIUM

(71) Applicant: FUJITSU LIMITED, Kawasaki-shi (JP)

(72) Inventors: Toru Kohei, Kawasaki (JP); Yuji Takahashi, Kawasaki (JP); TAKASHI YAMASAKI, Kawasaki (JP)

(21) Appl. No.: 14/805,878

(22) Filed: Jul. 22, 2015

(30) Foreign Application Priority Data
Aug. 4, 2014 (JP) 2014-159015

(51) Int. Cl. G06F 3/044

(52) U.S. Cl. CPC G06F 3/044

(57) ABSTRACT

An information processing apparatus detects contact of a finger with a capacitive panel. The information processing apparatus, when the contact of the finger is detected, measures a midpoint at an equal distance from either end of a contact region where the finger is in contact with the capacitive panel, and measures a centroid of an area of the contact region. The information processing apparatus executes operation depending on a distance between the measured midpoint of the contact region and the measured centroid of the area of the contact region.

### CROSS-REFERENCE TO RELATED APPLICATION

This application is based upon and claims the benefit of priority of the prior Japanese Patent Application No. 2014-159015 filed on Aug. 4, 2014, the entire contents of which are incorporated herein by reference.

### FIELD

The embodiments discussed herein are directed to an information processing apparatus, an input control method, and a computer-readable recording medium.

### BACKGROUND

In mobile terminals, such as smartphones, there is a known operation method, such as drag, in which movement of a finger is continuously detected. The drag operation is detected by obtaining a coordinate position corresponding to peak capacitance and continuously detecting the coordinate position by using a change in the capacitance on a touch panel. The mobile terminal performs processing, such as page turning, upon detecting the drag operation as mentioned above.

As a method of detecting a pressing force of a finger as well as a position of the finger or movement of the finger at the same time, there is a known structure in which a panel, such as a pressure-sensitive detection panel, is laid on the underside of a position capacitive panel. Further, to detect a pressure or the like, there is a known method using a pressure sensor that is used in a robot hand or the like. For example, the robot hand measures a position of the centroid of gravity by the pressure sensor, and controls a gripping force by using a change in the position.

Patent Literature 1: Japanese Laid-open Patent Publication No. 2006-297542

However, in a capacitive panel, such as a touch panel, it is difficult to accurately detect the pressure of a finger. Therefore, a mobile phone or the like using the touch panel is unable to accurately execute operation intended by a user. In the structure in which the pressure-sensitive detection panel is laid on the underside of the position capacitive panel, two circuits such as a circuit for detecting a position and a circuit for detecting a pressure are used, so that the scale of the circuits increases.

### SUMMARY

According to an aspect of an embodiment, an information processing apparatus includes a processor that executes a process. The process includes detecting contact of a finger with a capacitive panel; when the contact of the finger is detected at the detecting, measuring a midpoint at an equal distance from either end of a contact region where the finger is in contact with the capacitive panel, and measuring a centroid of an area of the contact region; and executing operation depending on a distance between the midpoint of the contact region and the centroid of the area of the contact region measured at the measuring.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a hardware configuration example of a mobile terminal;

FIG. 2 is a diagram for explaining details of a coordinate extraction processing unit;

FIG. 3 is a diagram illustrating an example of parameters extracted by the coordinate extraction processing unit;

FIG. 4 is a diagram illustrating a first example of parameters that the coordinate extraction processing unit sends to a processor;

FIG. 5 is a diagram illustrating a second example of the parameters that the coordinate extraction processing unit sends to the processor;

FIG. 6 is a diagram for explaining elastic deformation of a finger tip when the finger is pressed against a touch panel in a vertical direction;

FIG. 7 is a diagram for explaining a contact region when a finger is pressed against the touch panel from just above;

FIG. 8 is a diagram for explaining elastic deformation when a finger is pressed against the touch panel in the vertical direction and thereafter slid in an in-plane direction;

FIG. 9 is a diagram for explaining a contact region when a finger pressed against the touch panel moves to the right;

FIG. 10 is a flowchart illustrating the flow of a coordinate extraction process;

FIG. 11 is a diagram for explaining movement of a window without a finger pressure;

FIG. 12 is a diagram for explaining page turning with a finger pressure;

FIG. 13 is a flowchart illustrating the flow of a page turning determination process;

FIG. 14 is a diagram for explaining line drawing without a finger pressure;

FIG. 15 is a diagram for explaining line drawing with a finger pressure;

FIG. 16 is a flowchart illustrating the flow of a line drawing process;

FIG. 17 is a diagram for explaining free drawing without a finger pressure;

FIG. 18 is a diagram for explaining free drawing with a finger pressure; and

FIG. 19 is a flowchart illustrating the flow of a free drawing process.

### DESCRIPTION OF EMBODIMENTS

Preferred embodiments will be explained with reference to accompanying drawings. The present invention is not limited to the embodiments below. The embodiments may be arbitrarily combined as long as no contradiction is derived.

### [a] First Embodiment

### Overall Configuration

A mobile terminal according to a first embodiment described herein is assumed as a terminal, such as a smartphone, including a capacitive touch panel. The mobile terminal is a terminal enabled to perform operation of sending and receiving mails, sending and receiving calls, and operating various applications through the touch panel, and has the same functions as those of a general mobile phone. The mobile terminal is an example of an information processing apparatus. The mobile terminal may be a tablet terminal, a personal computer, a business-purpose mobile terminal, a portable game console, or the like.

The mobile terminal as described above detects contact of a finger with the capacitive touch panel. Upon detecting contact of a finger, the mobile terminal measures a midpoint at an equal distance from either end of a contact region where the finger is in contact with the touch panel, and a centroid of an area of the contact region. Then, the mobile terminal performs operation depending on a distance between the midpoint of the contact region and the centroid of the area of the contact region measured as above.

Therefore, the mobile terminal detects, as a pressure of a finger, a distance between the midpoint of the contact region of the finger operating the touch panel and the centroid of the area of the contact region, and performs operation depending on a detection result. Consequently, it is possible to realize user operation through detection of a pressure by using elastic deformation that occurs when a finger is pressed.

Hardware Configuration

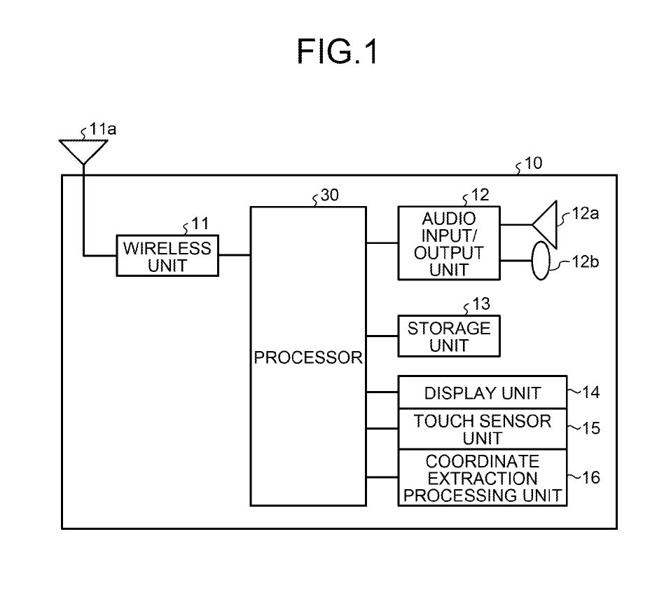

FIG. 1 is a diagram illustrating a hardware configuration example of the mobile terminal. As illustrated in FIG. 1, a mobile terminal 10 includes a wireless unit 11, an audio input/output unit 12, a storage unit 13, a display unit 14, a touch sensor unit 15, a coordinate extraction processing unit 16, and a processor 30. The hardware illustrated herein is an example, and may include other hardware, such as an acceleration sensor.

The wireless unit 11 performs wireless communication via an antenna 11a, and performs sending and receiving of mails or sending and receiving of calls, for example. The audio input/output unit 12 outputs various kinds of voice from a speaker 12a, and collects various kinds of voice from a microphone 12b.

The storage unit 13 is a storage device for storing various kinds of information, and is, for example, a hard disk or a memory. For example, the storage unit 13 stores therein various programs executed by the processor 30 or various kinds of data.

The display unit 14 is a display unit that displays various kinds of information, and is, for example, a display of the touch panel or the like. The touch sensor unit 15 is a sensor that detects contact of a finger or the like with the touch panel, and is, for example, a sensor installed in the display of the touch panel or the like. the coordinate extraction processing unit 16 is a circuit or the like that detects the coordinates or the like of a finger in contact with the touch panel, and details thereof will be described later.

The processor 30 is a processing unit that controls the entire processing of the mobile terminal 10 and executes various applications, and is, for example, a central processing unit (CPU) or the like. For example, the processor 30 specifies operation corresponding to information notified by the coordinate extraction processing unit 16, and performs the specified operation.

Details of Coordinate Extraction Processing Unit

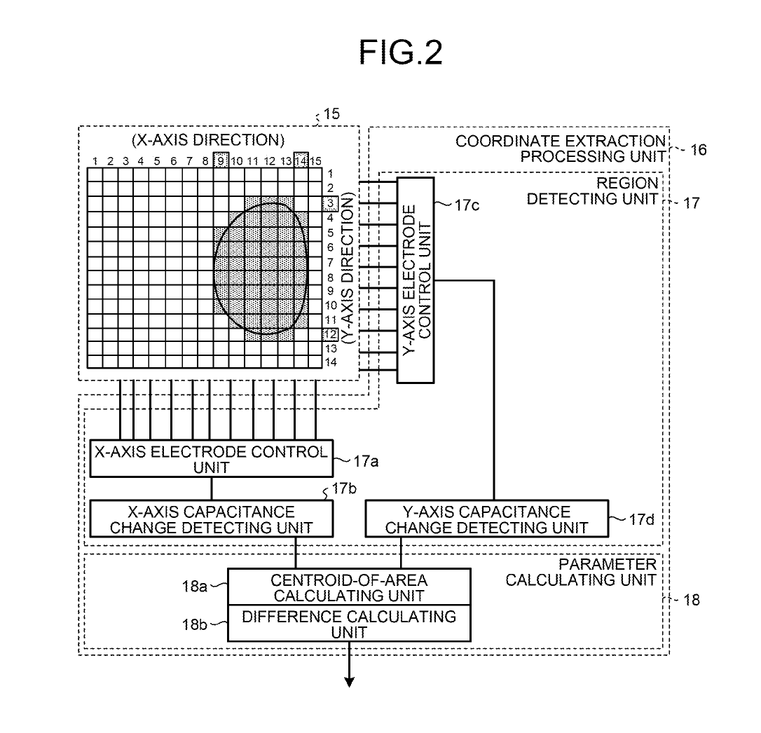

FIG. 2 is a diagram for explaining details of the coordinate extraction processing unit. As illustrated in FIG. 2, the coordinate extraction processing unit 16 includes a region detecting unit 17 and a parameter calculating unit 18.

The region detecting unit 17 is a circuit or the like that includes an X-axis electrode control unit 17a, an X-axis capacitance change detecting unit 17b, a Y-axis electrode control unit 17c, and a Y-axis capacitance change detecting unit 17d.

The X-axis electrode control unit 17a is a circuit connected to each of electrodes arranged on the touch sensor unit 15 in the X-axis direction, and detects ON and OFF of each of the electrodes. The X-axis capacitance change detecting unit 17b is a circuit that detects a capacitance value of each of the electrodes arranged in the X-axis direction in accordance with ON/OFF information input from the X-axis electrode control unit 17a.

The Y-axis electrode control unit 17c is a circuit connected to each of electrodes arranged on the touch sensor unit 15 in the Y-axis direction, and detects ON and OFF of each of the electrodes. The Y-axis capacitance change detecting unit 17d is a circuit that detects a capacitance value of each of the electrodes arranged in the Y-axis direction in accordance with ON/OFF information input from the Y-axis electrode control unit 17c.

The parameter calculating unit 18 is a circuit or the like that includes a centroid-of-area calculating unit 18a and a difference calculating unit 18b.

The centroid-of-area calculating unit 18a is a circuit that, when the touch sensor unit 15 detects contact of a finger, measures a centroid of an area of a contact region where the finger is in contact with the touch panel. Specifically, the centroid-of-area calculating unit 18a calculates coordinates (X_{g}, Y_{g}) of the centroid of the area contacted by the finger of a user, by using an ON region of the X-axis input from the X-axis capacitance change detecting unit 17b and an ON region of the Y-axis input from the Y-axis capacitance change detecting unit 17d.

For example, an example of a calculation method will be described with reference to FIG. 2. Herein, a contact region illustrated on the touch sensor unit 15 in FIG. 2 is taken as an example. A hatched portion in FIG. 2 is the contact region.

The centroid-of-area calculating unit 18a acquires an ON/OFF state of each of the electrodes from the region detecting unit 17, and outputs acquired information to the difference calculating unit 18b. Subsequently, the centroid-of-area calculating unit 18a calculates an area of the contact region of the X-axis by setting the coordinates of electrodes in the ON states to 1 and setting the coordinates of electrodes in the OFF states to 0 as for the X-axis, and divides a result of the calculation by the number of the electrodes in the ON states. For example, the centroid-of-area calculating unit 18a calculates such that “606/52≈11.7” by dividing “9×6+10×8+11×10+12×10+13×10+14×8=606” by the number “52” of the electrodes in the ON state.

Subsequently, the centroid-of-area calculating unit 18a calculates an area of the contact region of the Y-axis by setting the coordinates of electrodes in the ON states to 1 and setting the coordinates of electrodes in the OFF states to 0 as for the Y-axis, and divides a result of the calculation by the number of the electrodes in the ON states. For example, the centroid-of-area calculating unit 18a calculates such that “390/52=7.5” by dividing “3×3+4×5+5×6+6×6+7×6+8×6+9×6+10×6+11×5+12×3=390” by the number “52” of the electrodes in the ON state.

As described above, the centroid-of-area calculating unit 18a calculates the coordinates (X_{g}, Y_{g})=(11.7, 7.5) of the centroid of the area of the contact region, and outputs a result of the calculation to the difference calculating unit 18b. This calculation method is an example, and the centroid-of-area calculating unit 18a may calculate the coordinates of the centroid of the area by using various calculation methods used in computer-aided design (CAD) or the like.

The difference calculating unit 18b is a circuit that calculates a distance between the midpoint of the contact region where the finger is in contact with the touch panel and the centroid of the area of the contact region calculated by the centroid-of-area calculating unit 18a. For example, the difference calculating unit 18b acquires the ON region of the X-axis and the ON region of the Y-axis via the centroid-of-area calculating unit 18a. Subsequently, the difference calculating unit 18b specifies a maximum value and a minimum value in the ON region of the X-axis, and specifies a maximum value and a minimum value in the ON region of the Y-axis. In the example in FIG. 2, the difference calculating unit 18b specifies a maximum value of the X-axis as “Xₘₐₓ=14”, a minimum value of the X-axis as “Xₘᵢₙ=9”, a maximum value of the Y-axis as “Yₘₐₓ=12”, and a minimum value of the Y-axis as “Yₘᵢₙ=3”.

Thereafter, the difference calculating unit 18b calculates such that “(14+9)/2=11.5” by dividing (maximum value Xₘₐₓ+minimum value Xₘᵢₙ) by 2 as for the X-axis, and calculates such that “(12+3)/2=7.5” by dividing (maximum value Yₘₐₓ+minimum value Yₘᵢₙ) by 2 as for the Y-axis. As a result, the difference calculating unit 18b calculates coordinates (X_{cen}, Y_{cen}) of the midpoint as (5, 9).

Then, the difference calculating unit 18b calculates a magnitude Fo of a difference between the coordinates (X_{g}, Y_{g}) of the centroid of the area of the contact region and the coordinates (X_{cen}, Y_{cen}) of the midpoint. Specifically, the difference calculating unit 18b calculates such that “Fo=root((X_{g}−(Xₘₐₓ+Xₘᵢₙ)/2)²+(Y_{g}−(Yₘₐₓ+Yₘᵢₙ)/2)²)”.

Thereafter, the difference calculating unit 18b outputs various parameters acquired or calculated through the above described process to the processor 30. In this case, for example, the difference calculating unit 18b sends the above described Fo to the processor 30, and the processor 30 performs operation specified by the distance Fo (the magnitude Fo).

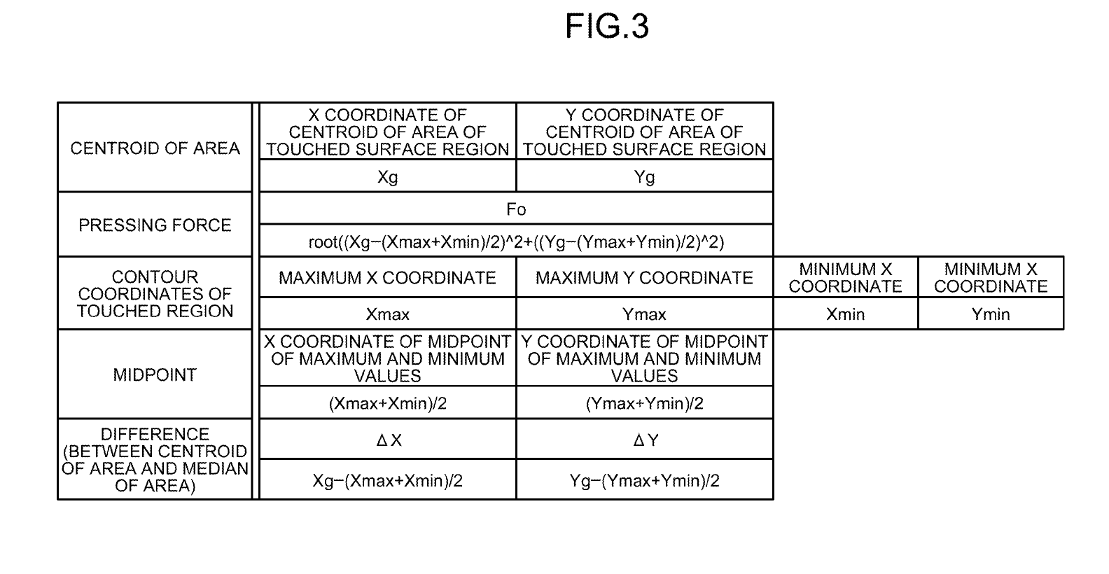

A list of the parameters acquired or calculated by the coordinate extraction processing unit 16 including the difference calculating unit 18b will be described below. FIG. 3 is a diagram illustrating examples of parameters extracted by the coordinate extraction processing unit. As illustrated in FIG. 3, the coordinate extraction processing unit 16 is enabled to calculate “a centroid of an area, a pressing force, contour coordinates of a touched region, a midpoint, and a difference”.

“The centroid of the area” is a value calculated by the centroid-of-area calculating unit 18a, and corresponds to the coordinates (X_{g}, Y_{g}) as described above. “The pressing force” is a value calculated by the difference calculating unit 18b, and corresponds to the above described Fo. “The contour coordinates of the touched region” is a value for specifying the contour of a contact region of a finger, and corresponds to “the maximum X coordinate (Xₘₐₓ), the minimum X coordinate (Xₘᵢₙ), the maximum Y coordinate (Yₘₐₓ), and the minimum Y coordinate (Yₘᵢₙ)” as described above.

“The midpoint” is the coordinates of the midpoint of the contact region calculated by the difference calculating unit 18b, and corresponds to the coordinates (X_{cen}, Y_{cen})=((Xₘₐₓ+Xₘᵢₙ)/2, (Yₘₐₓ+Yₘᵢₙ)/2) as described above. “The difference” is a difference between the centroid of the area and the midpoint in each of the axes, and corresponds to “X_{g}−(Xₘₐₓ+Xₘᵢₙ)/2” and “Y_{g}−(Yₘₐₓ+Yₘᵢₙ)/2” as described above.

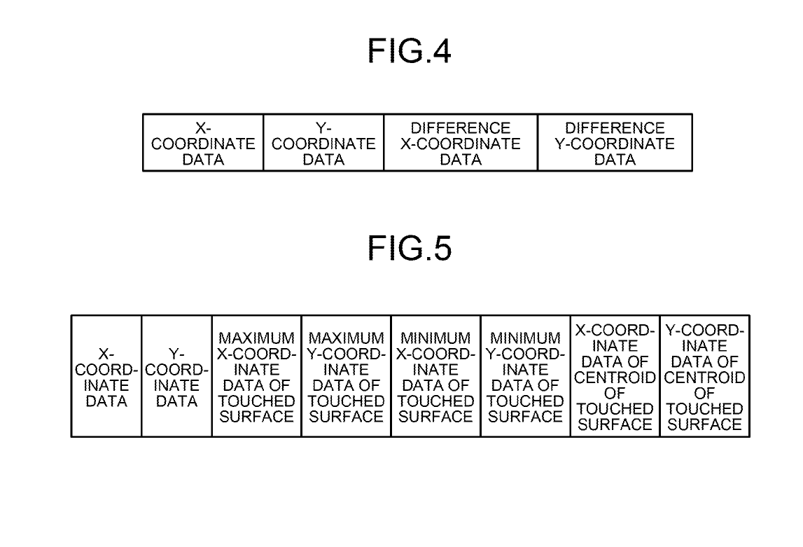

Next, examples of parameters that the coordinate extraction processing unit 16 including the difference calculating unit 18b sends to the processor 30 will be described. FIG. 4 is a diagram illustrating a first example of the parameters that the coordinate extraction processing unit sends to the processor. FIG. 5 is a diagram illustrating a second example of the parameters that the coordinate extraction processing unit sends to the processor.

As illustrated in FIG. 4, the difference calculating unit 18b is enabled to send “X-coordinate data, Y-coordinate data, difference X-coordinate data, and difference Y-coordinate data” to the processor. “The X-coordinate data and the Y-coordinate data” are the coordinates (X_{cen}, Y_{cen}) of the midpoint, and “the difference X-coordinate data and the difference Y-coordinate data” are “X_{g}−(Xₘₐₓ+Xₘᵢₙ)/2, Y_{g}−Yₘₐₓ+Yₘᵢₙ)/2”

Further, as illustrated in FIG. 5, the difference calculating unit 18b is enabled to send “X-coordinate data, Y-coordinate data, maximum X-coordinate data of a touched surface, maximum Y-coordinate data of the touched surface, minimum X-coordinate data of the touched surface, minimum Y-coordinate data of the touched surface, X-coordinate data of a centroid of the touched surface, and Y-coordinate data of a centroid of the touched surface” to the processor. “The X-coordinate data and the Y-coordinate data” are the coordinates (X_{cen}, Y_{cen}) of the midpoint, and “the difference X-coordinate data and the difference Y-coordinate data” are “X_{g}−(Xₘₐₓ+Xₘᵢₙ)/2, Y_{g}−(Yₘₐₓ+Yₘᵢₙ)/2”.

“The maximum X-coordinate data of the touched surface and the maximum Y-coordinate data of the touched surface” correspond to (Xₘₐₓ, Yₘₐₓ) and “the minimum X-coordinate data of the touched surface and the minimum Y-coordinate data of the touched surface” correspond to (Xₘᵢₙ, Yₘᵢₙ). Further, “the X-coordinate data of the centroid of the touched surface and the Y-coordinate data of the centroid of the touched surface” correspond to (X_{g}, Y_{g}).

### Contact Example

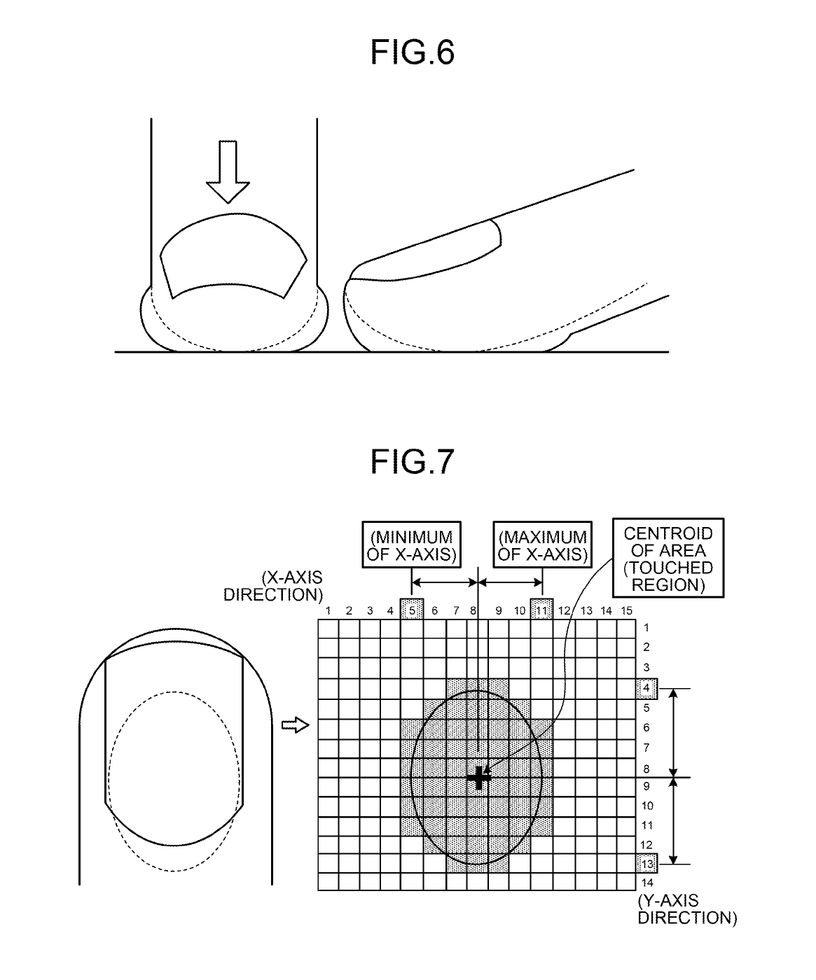

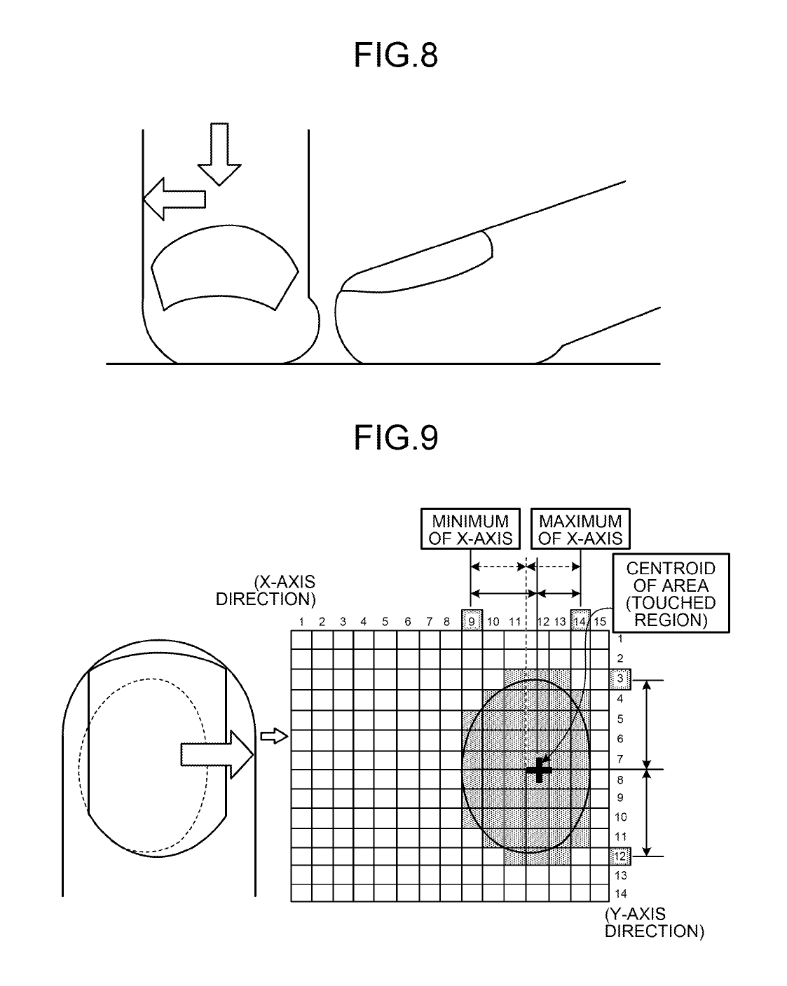

Next, a coordinate relation when a finger comes in contact with the touch panel will be described with reference to FIG. 6 to FIG. 9. FIG. 6 is a diagram for explaining elastic deformation of a finger tip when the finger is pressed against the touch panel in the vertical direction. FIG. 7 is a diagram for explaining a contact region when a finger is pressed against the touch panel from just above. FIG. 8 is a diagram for explaining elastic deformation when a finger is pressed against the touch panel in the vertical direction and thereafter slid in the in-plane direction. FIG. 9 is a diagram for explaining a contact region when a finger pressed against the touch panel moves to the right.

As illustrated in FIG. 6, when a finger is pressed against the touch panel in the vertical direction, the finger is elastically deformed in a bilaterally symmetrical manner. Therefore, as illustrated in FIG. 7, a contact region of the finger is bilaterally and vertically symmetric with respect to the midpoint. As a result, the midpoint of the contact region and the centroid of the area of the contact region coincide with each other. In the case in FIG. 7, the maximum value and the minimum value of the X-axis in the contact region are 11 and 5, and the maximum value and the minimum value of the Y-axis are 13 and 4, respectively, so that the coordinates of the midpoint are (8, 8.5) and the coordinates of the centroid of the area are also (8, 8.5). Namely, the above described Fo is zero.

In contrast, as illustrated in FIG. 8, when a finger is pressed against the touch panel in the vertical direction and thereafter slid in the horizontal direction, the finger is elastically deformed so as to be stretched in a direction opposite to the moving direction. In the example in FIG. 8, a user moves the finger to the right, so that the finger is elastically deformed so as to be stretched to the left. Therefore, as illustrated in FIG. 9, the contact region of the finger is not bilaterally or vertically symmetric with respect to the midpoint, so that the midpoint of the contact region and the centroid of the area of the contact region are deviated from each other. In the case in FIG. 9, the maximum value and the minimum value of the X-axis in the contact region are 14 and 9, and the maximum value and the minimum value of the Y-axis are 12 and 3, respectively, so that the coordinates of the midpoint are (11.5, 7.5). In contrast, the coordinates of the centroid of the area are (11.7, 7.5) through the calculation as described above. Namely, the above described Fo is greater than zero.

Coordinate Extraction Process

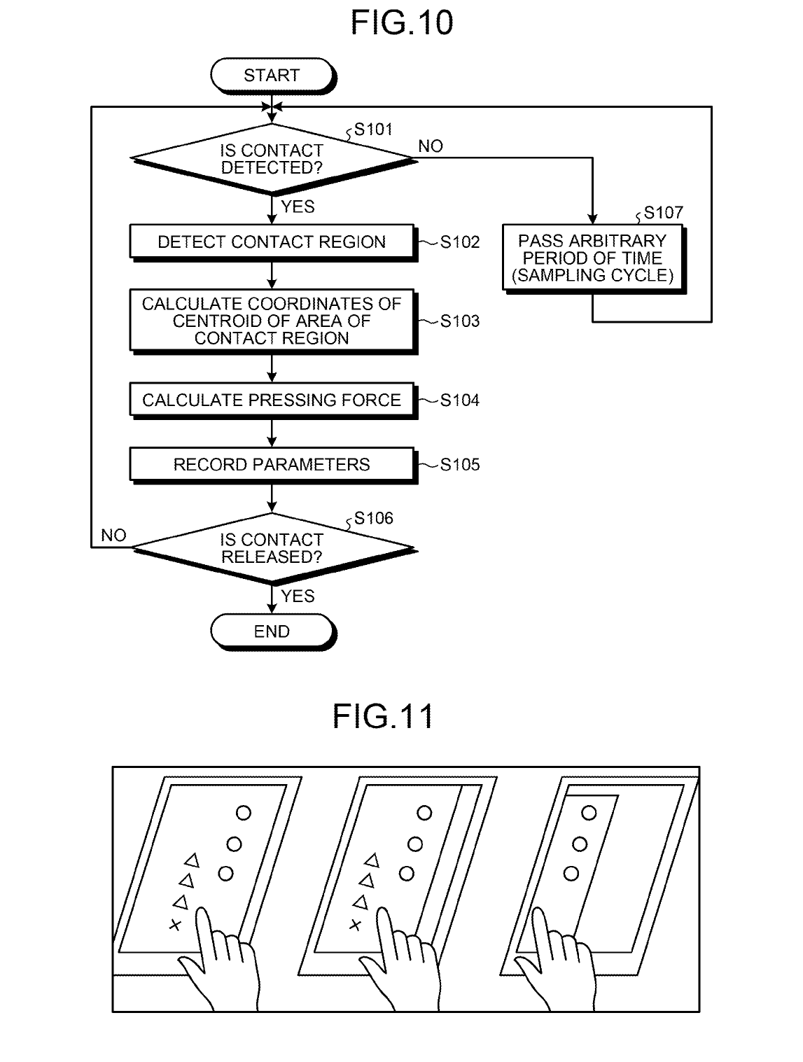

FIG. 10 is a flowchart illustrating the flow of a coordinate extraction process. As illustrated in FIG. 10, upon detecting that a finger is in contact with the touch panel (YES at Step S101), the region detecting unit 17 detects a contact region (Step S102). For example, the region detecting unit 17 detects a maximum value Xₘₐₓ in the X-axis direction, a minimum value Xₘᵢₙ in the X-axis direction, a maximum value Yₘₐₓ in the Y-axis direction, and a minimum value Yₘᵢₙ in the Y-axis direction.

Subsequently, the parameter calculating unit 18 calculates a centroid of an area of the contact region (Step S103). Thereafter, the parameter calculating unit 18 calculates a pressing force (Fo) of the finger, that is, a distance between the midpoint of the contact region and the centroid of the area of the contact region (Step S104), and stores parameters including various parameters being calculated and Fo in a memory or the like (Step S105). For example, the parameter calculating unit 18 stores the parameters as illustrated in FIG. 3.

Upon detecting that the contact of the finger is released (YES at Step S106), the region detecting unit 17 terminates the process. While the contact of the finger is maintained (NO at Step S106), the process is repeated from Step S101. At Step S101, while not detecting contact of a finger with the touch panel (NO at Step S101), the region detecting unit 17 repeats a process at Step S101 at a timing of an arbitrary period of time (sampling cycle) (Step S107).

### Advantageous Effects

As described above, when a user presses a finger against the touch panel, the finger may be elastically deformed in a bilaterally non-symmetrical manner, and the midpoint of a contact region and the centroid of the area of the contact region may be deviated from each other. By converting the “deviation” to the pressure of the finger, it is possible to distinguish whether the user simply places the finger or the user strongly presses the finger as if the user turns a page.

Namely, it is possible to obtain a pressing force of the finger in a panel direction at the time of dragging, by using a relation among elastic characteristics of the finger, a pressing force of the finger, and a dragging force on the touch panel on the basis of a difference between the midpoint of the maximum and minimum values of a finger-touched area region and the coordinates of the centroid of the touched area region. Consequently, it is possible to easily provide a new operation parameter such as a pressing force during dragging.

### [b] Second Embodiment

A specific example of operation, in which the pressing force (Fo) of the finger described in the first embodiment is used as a new operation parameter, will be explained below.

Page Turning

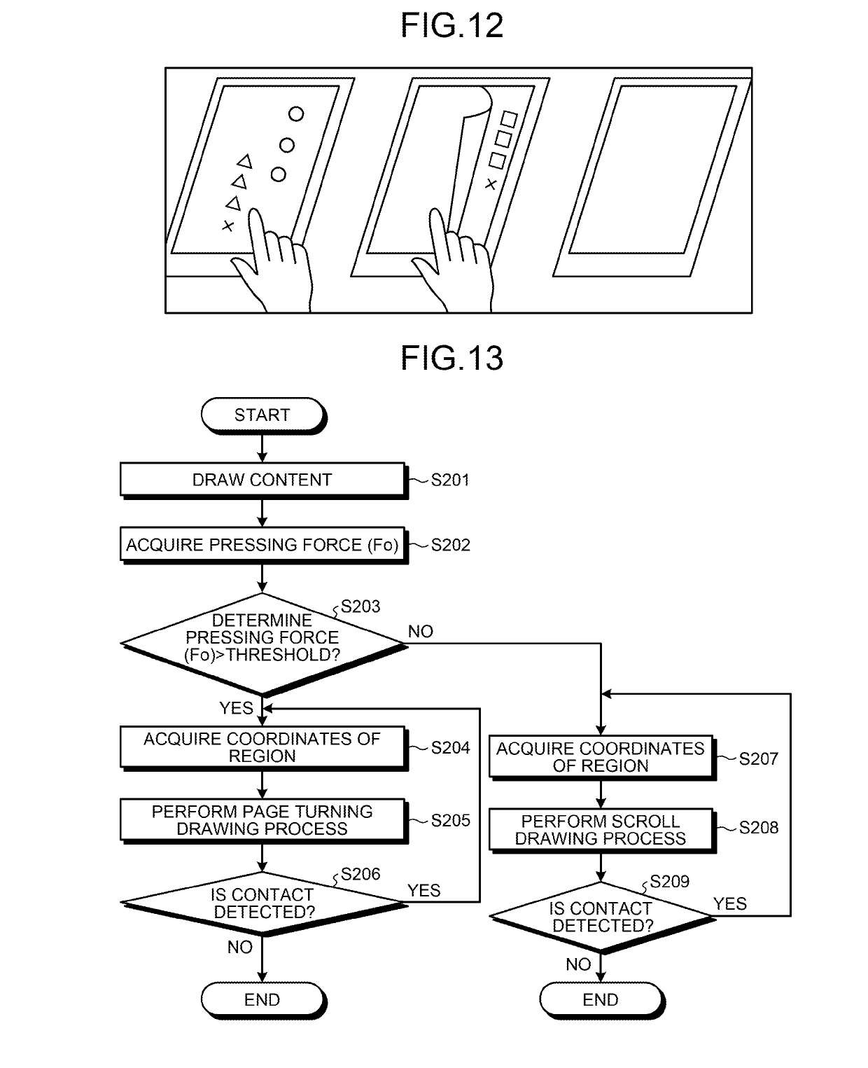

First, page turning operation using the the pressing force (Fo) of the finger will be described with reference to FIG. 11 to FIG. 13. FIG. 11 is a diagram for explaining movement of a window without a finger pressure. FIG. 12 is a diagram for explaining page turning with a finger pressure.

When a pressing force of a finger is weak, the finger is elastically deformed in an approximately bilaterally symmetrical manner, and the pressing force (Fo) of the finger is smaller than a threshold. In this case, as illustrated in FIG. 11, the mobile terminal 10 determines that operation of moving a window displayed on the touch panel is performed, and moves the window.

In contrast, when a pressing force of a finger is strong, the finger is elastically deformed in a bilaterally non-symmetrical manner, and the pressing force (Fo) of the finger is greater than the threshold. In this case, as illustrated in FIG. 12, the mobile terminal 10 determines that operation of turning a page of a window displayed on the touch panel is performed, and displays a next page.

FIG. 13 is a flowchart illustrating the flow of a page turning determination process. As illustrated in FIG. 13, the processor 30 draws a content on the display unit 14 that is the touch panel (Step S201).

Subsequently, the processor 30 acquires the pressing force (Fo) of a finger from the coordinate extraction processing unit 16 (Step S202), and determines whether the pressing force (Fo) of the finger is greater than a threshold (Step S203).

If the pressing force (Fo) of the finger is greater than the threshold (YES at Step S203), the processor 30 acquires coordinates of a region pressed by the finger (Step S204), and performs a page turning drawing process (Step S205). For example, the processor 30 acquires the coordinates (X_{g}, Y_{g}) of the centroid of the area from the coordinate extraction processing unit 16, and performs page turning by using the coordinates as an origin.

While the contact of the finger is maintained (YES at Step S206), the processor 30 repeats the process from Step S204, and upon detecting that the contact of the finger is released (NO at Step S206), the processor 30 terminates the process.

In contrast, if the pressing force (Fo) of the finger is equal to or smaller than the threshold (NO at Step S203), the processor 30 acquires the coordinates of a region pressed by the finger (Step S207), and performs a scroll drawing process (Step S208). For example, the processor 30 acquires the coordinates of the midpoint from the coordinate extraction processing unit 16, and moves a window by using the coordinates as an origin.

While the contact of the finger is maintained (YES at Step S209), the processor 30 repeats the process from Step S207, and upon detecting that the contact of the finger is released (NO at Step S209), the processor 30 terminates the process.

As described above, the mobile terminal 10 is enabled to discriminate between processes depending on the magnitude of the pressing force (Fo) of the finger. Therefore, it is possible to accurately perform operation intended by a user.

Line Drawing

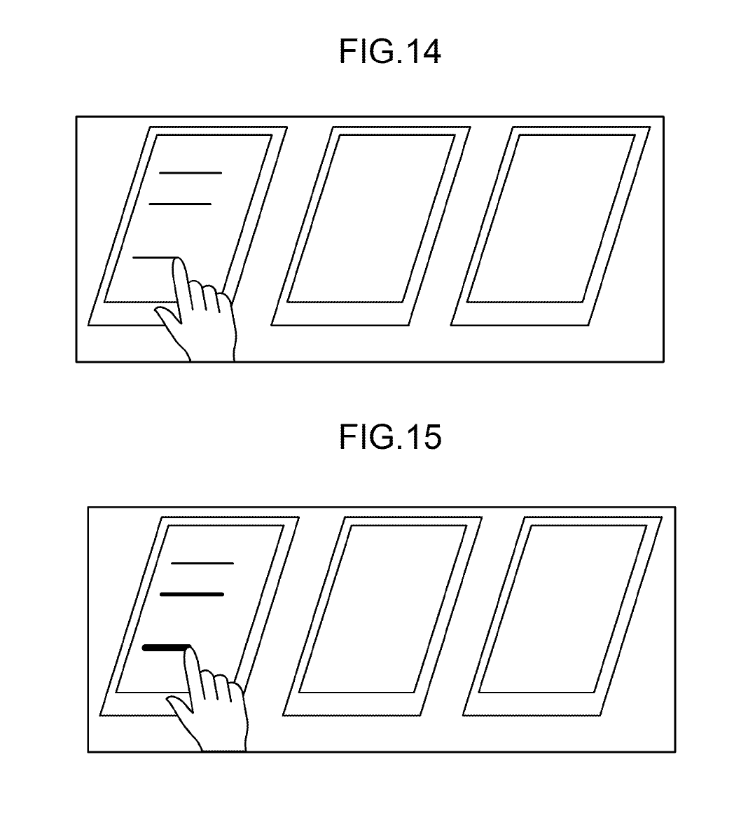

Line drawing operation using the pressing force (Fo) of the finger will be described below with reference to FIG. 14 to FIG. 16. FIG. 14 is a diagram for explaining line drawing without a finger pressure. FIG. 15 is a diagram for explaining line drawing with a finger pressure.

A conventional mobile terminal is unable to detect a pressing force of a finger, and is only enabled to determine whether a finger is in contact or not. Therefore, as illustrated in FIG. 14, the conventional mobile terminal determines only that a finger is simply in contact even when a user increases the pressing force of the finger to draw a thick line or the user decreases the pressing force of the finger to draw a thin line, and therefore draws lines with the same thickness.

In contrast, the mobile terminal 10 described in the embodiments is enabled to detect a magnitude of the pressing force (Fo) of the finger in addition to whether the finger is in contact or not. Therefore, as illustrated in FIG. 15, the mobile terminal 10 draws a thick line when the user increases the pressing force of the finger, and draws a thin line when the user decreases the pressing force of the finger.

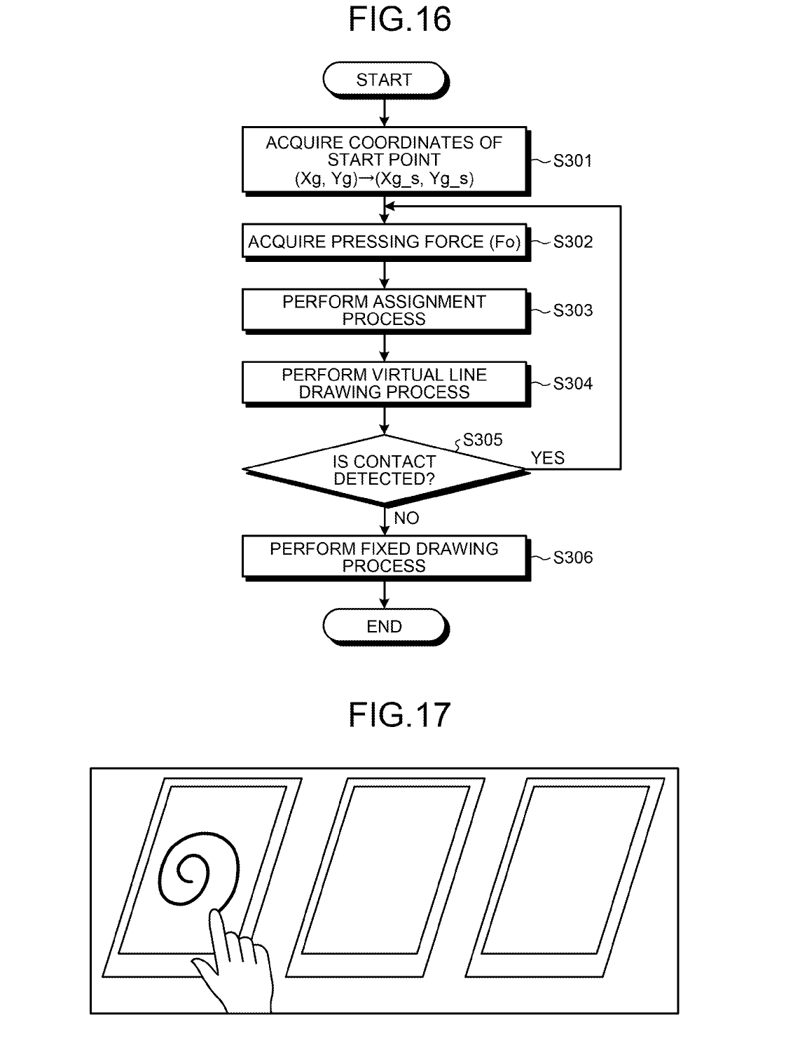

FIG. 16 is a flowchart illustrating the flow of a line drawing process. As illustrated in FIG. 16, the processor 30 acquires the coordinates of a start point from the coordinate extraction processing unit 16 (Step S301). For example, the processor 30 assigns the coordinates (X_{g}, Y_{g}) of the centroid of the area of the contact region to the start point (X_{g}_{_{—}}ₛ, Y_{g}_{_{—}}ₛ).

Subsequently, the processor 30 acquires the pressing force (Fo) of the finger from the coordinate extraction processing unit 16 (Step S302), and performs an assignment process (Step S303). For example, the processor 30 assigns the coordinates (X_{g}, Y_{g}) of the centroid of the area, which is obtained when the movement of the finger is stopped, to an end point (X_{g}_{_{—}}ₑ, Y_{g}_{_{—}}ₑ), and assigns the pressing force (Fo) of the finger at the start point to a thickness (TL).

Thereafter, the processor 30 performs a virtual line drawing process by using a result of the assignment process (Step S304). For example, the processor 30 draws a temporary line with the thickness (TL) from the start point (X_{g}_{_{—}}ₛ, Y_{g}_{_{—}}ₛ) to the end point (X_{g}_{_{—}}ₑ, Y_{g}_{_{—}}ₑ).

While the contact of the finger is maintained (YES at Step S305), the processor 30 repeats the process from Step S302, and upon detecting that the contact of a finger is released (NO at Step S305), the processor 30 performs a fixed drawing process (Step S306). For example, the processor 30 fixes the line drawn as the temporary line in the temporary line drawing process.

As described above, the mobile terminal 10 is enabled to draw a line with a thickness depending on the magnitude of the pressing force (Fo) of the finger. Conventionally, the thickness of a line to be drawn varies depending on the thickness (size) of a finger, that is, depending on the size of a body; therefore, the convenience for a user is reduced. However, the mobile terminal 10 is enabled to change a thickness of a line by the pressing force of a finger independent of the size of a body or the thickness (size) of a finger; therefore, the convenience for a user can be improved.

Free Drawing

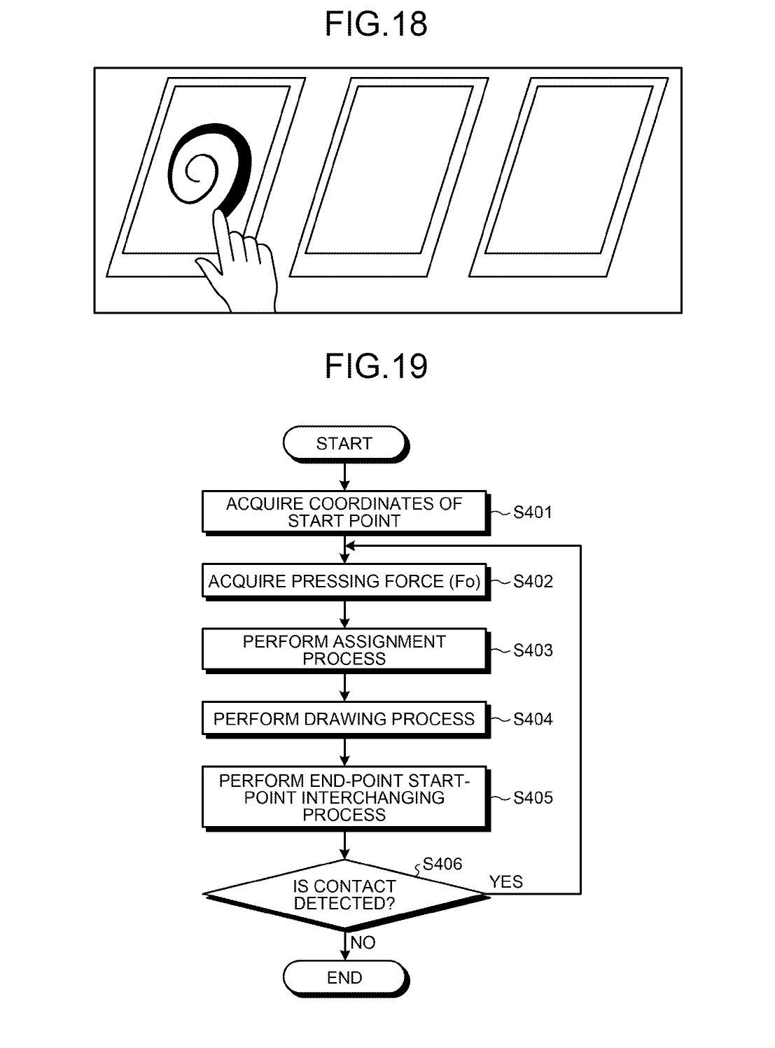

Free drawing operation using the pressing force (Fo) of the finger will be described below with reference to FIG. 17 to FIG. 19. FIG. 17 is a diagram for explaining free drawing without a finger pressure. FIG. 18 is a diagram for explaining free drawing with a finger pressure.

A conventional mobile terminal is unable to detect a pressing force of a finger, and is only enabled to determine whether a finger is in contact or not. Therefore, as illustrated in FIG. 17, the conventional mobile terminal determines only that a finger is simply in contact even when a user increases the pressing force of the finger to draw a thick line or the user decreases the pressing force of the finger to draw a thin line. Therefore, the conventional mobile terminal basically draws a line with the same thickness during drawing.

In contrast, the mobile terminal 10 described in the embodiments is enabled to detect a magnitude of the pressing force (Fo) of the finger in addition to whether the finger is in contact or not. Therefore, as illustrated in FIG. 18, even during drawing, the mobile terminal 10 draws a thick line when the user increases the pressing force of the finger, and draws a thin line when the user decreases the pressing force of the finger.

FIG. 19 is a flowchart illustrating the flow of a free drawing process. As illustrated in FIG. 19, the processor 30 acquires the coordinates of a start point from the coordinate extraction processing unit 16 (Step S401). For example, the processor 30 assigns the coordinates (X_{g}, Y_{g}) of the centroid of the area of the contact region to the start point (X_{g}_{_{—}}ₛ, Y_{g}_{_{—}}ₛ).

Subsequently, the processor 30 acquires the pressing force (Fo) of the finger from the coordinate extraction processing unit 16 (Step S402), and performs an assignment process (Step S403). For example, the processor 30 assigns the coordinates (X_{g}, Y_{g}) of the centroid of the area, which is obtained when the pressing force (Fo) of the finger is changed, to the end point (X_{g}_{_{—}}ₑ, Y_{g}_{_{—}}ₑ), and assigns the pressing force (Fo) of the finger before the change to the thickness (TL).

Thereafter, the processor 30 performs a line drawing process by using a result of the assignment process (Step S404). For example, the processor 30 draws a temporary line with the thickness (TL) from the start point (X_{g}_{_{—}}ₛ, Y_{g}_{_{—}}ₛ) to the end point (X_{g}_{_{—}}ₑ, Y_{g}_{_{—}}ₑ).

Then, the processor 30 performs an end-point start-point interchanging process (Step S405). For example, the processor 30 sets the end point (X_{g}_{_{—}}ₑ, Y_{g}_{_{—}}ₑ) to a new start point (X_{g}_{_{—}}ₛ, Y_{g}_{_{—}}ₛ).

Thereafter, while the contact of the finger is maintained (YES at Step S406), the processor 30 repeats the process from Step S402, and upon detecting that the contact of the finger is released (NO at Step S406), the processor 30 terminates the process.

As described above, the mobile terminal 10 is enabled to draw a line with a thickness depending on the magnitude of the pressing force (Fo) of the finger. Therefore, the mobile terminal 10 is enabled to freely change a thickness of a line even during drawing of the line.

### [c] Third Embodiment

While the embodiments of the disclosed technology have been explained above, the disclosed technology may be embodied in various forms other than the embodiments as described above.

System

The components of the apparatuses illustrated in the drawings are not always physically configured in the manner illustrated in the drawings. In other words, the components may be distributed or integrated in an arbitrary unit. Further, for each processing function performed by each apparatus, all or any part of the processing function may be implemented by a CPU and a program analyzed and executed by the CPU or may be implemented as hardware by wired logic.

Of the processes described in the embodiments, all or part of a process described as being performed automatically may be performed manually. Alternatively, all or part of a process described as being performed manually may also be performed automatically by known methods. In addition, the processing procedures, control procedures, specific names, and information including various kinds of data and parameters illustrated in the above-described document and drawings may be arbitrarily changed unless otherwise specified.

The mobile terminal 10 described in the embodiments is enabled to read and execute an input control program to implement the same functions as the processes described in FIG. 2 or the like. For example, the mobile terminal 10 loads, on a memory, a program having the same functions as those of the X-axis electrode control unit 17a, the X-axis capacitance change detecting unit 17b, the Y-axis electrode control unit 17c, the Y-axis capacitance change detecting unit 17d, the centroid-of-area calculating unit 18a, and the difference calculating unit 18b. Subsequently, the mobile terminal 10 executes a process for implementing the same processes as those of the X-axis electrode control unit 17a, the X-axis capacitance change detecting unit 17b, the Y-axis electrode control unit 17c, the Y-axis capacitance change detecting unit 17d, the centroid-of-area calculating unit 18a, and the difference calculating unit 18b, thereby executing the same processes as those of the embodiments as described above.

The program may be distributed via a network, such as the Internet. The program may be recorded in a computer-readable recording medium, such as a hard disk, a flexible disk (FD), a compact disc ROM (CD-ROM), a magneto-optical disk (MO), a digital versatile disk (DVD), or a secure digital (SD) memory card, and may be executed by being read from the recording medium by a computer.

According to an embodiment, it is possible to perform user operation depending on a pressing force of a finger by using a capacitive panel.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a processor that executes a process including:
detecting contact of a finger with a capacitive panel;
when the contact of the finger is detected at the detecting, measuring a midpoint at an equal distance from either end of a contact region where the finger is in contact with the capacitive panel, and measuring a centroid of an area of the contact region; and
executing operation depending on a distance between the midpoint of the contact region and the centroid of the area of the contact region measured at the measuring.

2. The information processing apparatus according to claim 1, wherein, the measuring includes assuming that a region of the capacitive panel is defined by an X-axis and a Y-axis, and calculating, as the midpoint, an average value of a maximum value and a minimum value of the contact region in an X-axis direction and an average value of a maximum value and a minimum value of the contact region in a Y-axis direction.

3. The information processing apparatus according to claim 1, wherein when a predetermined screen is displayed on a display unit using the capacitive panel, the executing includes sliding the predetermined screen when a distance between the midpoint of the contact region and the centroid of the area of the contact region is smaller than a predetermined value, and turning a page of the predetermined screen when the distance is equal to or greater than the predetermined value.

4. The information processing apparatus according to claim 1, wherein when the finger is in contact with a display unit using the capacitive panel and the finger moves on the display unit, the executing includes displaying a line with a thickness corresponding to a distance between the midpoint of the contact region and the centroid of the area of the contact region.

5. An input control method comprising:
detecting contact of a finger with a capacitive panel;
measuring, when the contact of the finger is detected, a midpoint at an equal distance from either end of a contact region where the finger is in contact with the capacitive panel, and a centroid of an area of the contact region; and
executing operation depending on a distance between the midpoint of the contact region and the centroid of the area of the contact region measured at the measuring.

6. A computer-readable recording medium having stored therein a program that causes a computer to execute an input control process comprising:
detecting contact of a finger with a capacitive panel;
measuring, when the contact of the finger is detected, a midpoint at an equal distance from either end of a contact region where the finger is in contact with the capacitive panel, and a centroid of an area of the contact region; and
executing operation depending on a distance between the midpoint of the contact region and the centroid of the area of the contact region measured at the measuring.
